(19) United States
(12) Patent Application Publication
(10) Pub. No.: US 2026/0147133 A1
(43) Pub. Date: May 28, 2026

(54) MONITORING SYSTEM FOR IDENTIFYING DEFECTS IN WELLBORE TUBING AND RODS

(71) Applicants: Collin Rickey Morris, Marshall (CA); ACE-EMI Software LLC, Dallas, TX (US)

(72) Inventors: Collin Rickey Morris, Marshall (CA); Alyan Tiffany Abdul, Austin, TX (US); Enio Rafael Maita Oliveros, Montgomery, TX (US)

(21) Appl. No.: 19/402,591

(22) Filed: Nov. 26, 2025

Related U.S. Application Data
(60) Provisional application No. 63/724,973, filed on Nov. 26, 2024.

(51) Int. Cl. G01V 3/26; E21B 47/00; G08B 21/18

(52) U.S. Cl. CPC G01V 3/26; E21B 47/00; G08B 21/18

(57) ABSTRACT

An apparatus monitors defects in a wellbore string, for example tubing or rods, withdrawn from a wellbore using a plurality of monitoring sensors including at least one electromagnetic sensor generating a magnetic flux leakage signal and a controller. The controller processes the monitoring signals to identify one or more defect anomalies for comparison to at least one defect criterium to determine if the section is defective. A notification is generated based on the determination that the section is defective. The controller may further calculate (i) a withdrawal speed of the wellbore string based upon the processed monitoring signals and (ii) a count of withdrawn sections based upon repeating anomalies identified in the monitoring signals. The monitoring sensors are calibrated to balance baseline values between the monitoring signals when the monitoring signals indicate a repeating anomaly corresponding to a joint, for example between sections and/or when the string is at rest.

### FIELD OF THE INVENTION

The present invention relates to a monitoring apparatus for monitoring sections of a wellbore string, for example a tubing string or a rod string, as the sections of the wellbore string are withdrawn from a wellbore, and more particularly the present invention relates to a monitoring apparatus for detecting defects in the sections of the wellbore string, calculating withdrawal speed, and/or counting the number of sections during withdrawal of the wellbore string from the wellbore.

### BACKGROUND

Currently, EMI (electromagnetic inspection) equipment is used to inspect tubulars worldwide. In many cases, the EMI unit is placed directly over the wellbore, on the rig floor, and the pipe is pulled directly from the well, through the unit. This gives real time inspection. The unit works by magnetically saturating the tubular sections as the tubing string travels through the unit, and then reads how much variation of flux density, and/or rate of change of magnetic fields, or magnetic flux leakage (MFL), has occurred to determine if material/metal (wall thickness, holes etc.) has been lost. Basically, if material/metal has been lost from the tubular, the electromagnetic signal changes, and the EMI units will display this on a real time graph. This loss of material/wall thickness determines future use, or replacement and represents significant cost in the oil and gas industry. Getting it correct is critical.

The attending human must then interpret those signals/graphs and determine how much material (typically referred to as wall thickness), if any, has been lost. The operator is responsible for interpreting the graph and grading the pipe's quality and condition using the API spec 5ct colour grading system. As mentioned above, the data is currently displayed as a single graph, or series of overlayed graphs, depending on the type of EMI hardware being used. It looks much like an ECG (electromagnetic Cardiogram), and is just as difficult to read, thus requires a specialist to interpret the graph and grade the pipe. Training people to read the signals accurately and consistently is very time consuming, and results in inconsistencies in interpretations of the graphs, leading to tubulars either being used that are worn out, or being discarded when they are still fit for service.

These inconsistencies are exasperated by the movement and vibrations of the operating equipment (typically a production rig of some sort). The repositioning of the tongs slips and elevators, as well as any metal objects such as tools, boots, etc. that may move past, get close or come into contact with the EMI unit while operating cause mechanical interference that can distort the EMI field, resulting in false indicators of degraded material.

The speed the rig is pulling the pipe through the unit is also a variable as the speed is constantly changing, starting and stopping. These factors need to be anticipated by the operator, and changes made to the axes on the graph to compensate for the change and so the information continues to fit in the viewing area of the graph. Additionally, a decision for pipe grading must be given at the time the tubular is extracted, and the operator is required to keep count of the amount of tubular being pulled out of the hole, which is normally done manually. In many cases all the decisions assessments and annotations need to be made as quick as every 15 seconds.

All these variables lead to mistakes, as it is very difficult for the operator to absorb the data, interpret the visual info, and then make a determination before the next tubular has already started to be pulled.

### SUMMARY OF THE INVENTION

The tubing monitoring apparatus described herein is an electromagnetic inspection system using software and additional retrofitted hardware sensors to interpret magnetic flux leakage (MFL) and other data from EMI sensors in an Electromagnetic Imaging (EMI) unit. A combination of designed software and retrofitted hardware seeks to provide a solution for at least some of the current problems associated with conventional monitoring systems. The tubing monitoring apparatus incorporates all the above-mentioned variables in real time and gives the operator a final colour grade and number of tubulars count instantly. By doing this, training of operators is vastly simplified, and consistency in correctly identifying the grade of pipe is greatly increased.

According to one aspect of the present invention there is provided a monitoring apparatus for monitoring sections of a wellbore string for defects in the sections as the wellbore string is withdrawn from a wellbore, the apparatus comprising:
a plurality of monitoring sensors arranged to (i) be supported above the wellbore in proximity to the wellbore string and (ii) generate respective monitoring signals, in which the monitoring sensors include at least one electromagnetic sensor such that the respective monitoring signal of said at least one electromagnetic sensor includes a magnetic flux leakage signal corresponding to a measured magnetic flux leakage of the wellbore string;
a controller operatively connected to the monitoring sensors, the controller comprising a memory storing programming instructions and a processor arranged to process the programming instructions so as to be arranged to:
   (i) process the monitoring signals from the monitoring sensors as the wellbore string is withdrawn from the wellbore to identify one or more defect anomalies in the monitoring signals which may relate to defects in the wellbore string;
   (ii) for each section, compare the one or more defect anomalies to at least one defect criterium stored on the controller to determine if the section of the wellbore string associated with one or more of the defect anomalies is defective; and
   (iii) generate a notification based on the determination that one of the sections is determined to be defective.

The apparatus is applicable for detecting defects in various types of wellbore strings including defects in tubing sections of a tubing string or rod sections of a rod string for example.

The monitoring signal at the end of a section results in an anomaly, otherwise defined herein as a signal disturbance in a pattern, that the algorithm on the controller can detect for subsequent use of the identification of the ends of the sections in other tasks.

The controller is preferably arranged to process the monitoring signals from the monitoring sensors in real time as the wellbore string is withdrawn from the wellbore to distinguish the defect anomalies in the monitoring signals from non-defect anomalies not relating to defects in the wellbore string.

The controller may be arranged to process the monitoring signals to identify the defect anomalies by combining features from the monitoring signals of the plurality of monitoring sensors.

The at least one electromagnetic sensor comprises a plurality of electromagnetic sensors in which one or more of the electromagnetic sensors are oriented radially of the wellbore string and one or more of the electromagnetic sensors are oriented parallel or tangentially of the wellbore string.

The at least one defect criterium preferably includes one or more thresholds against which the identified defect anomalies of the monitoring signals are compared.

When the monitoring signals further include a magnetic flux density signal corresponding to a measured flux density of the wellbore string, the controller is preferably arranged to process the monitoring signals to determine if the section of the wellbore is defective by (i) identifying portions of the magnetic flux leakage signal that are relevant to defects in the wellbore string, (ii) process corresponding portions of the magnetic flux density signal that correspond to the identified portions of the magnetic flux leakage signal to generate an accumulated differential signal, in which the accumulated differential signal represents an accumulated differential of the magnetic flux density signal for each of said corresponding portions of the magnetic flux density signal, and (iii) compare at least a portion of the accumulated differential signal to said at least one defect criterium.

When said at least one defect criterium includes a defect threshold, the controller may be further arranged to compare a maximum peak of the accumulated differential signal associated with the section of the wellbore string to the defect threshold to determine if the section of the wellbore is defective.

The controller may be arranged to identify said portions of the magnetic flux leakage signal that are relevant to defects in the wellbore string by (i) identifying repeating anomalies in the monitoring signals which are periodically repeated corresponding to joints between the sections of the wellbore string, (ii) identifying a region of the magnetic flux signal between two of the repeating anomalies as being associated with one section of the wellbore string, and (iii) comparing said identified region of the magnetic flux leakage signal to a minimum threshold.

The controller may be further arranged to calculate withdrawal speed of the wellbore string being withdrawn from the wellbore and use the withdrawal speed in processing the monitoring signals to determine if the section is defective. More particularly, the controller may be arranged to (i) determine if the calculated withdrawal speed falls outside of a default speed and (ii) when the calculated withdrawal speed is determined to be outside of a default speed, apply a correction factor to the identified defect anomalies of the monitoring signals prior to comparison of the defect anomalies to the defect criterium to determine if the section of the wellbore string associated with one or more of the defect anomalies is defective.

The controller may be further arranged to (i) process the monitoring signals to identify repeating anomalies in the monitoring signals which are periodically repeated corresponding to joints between the sections of the wellbore string, and (ii) calculate a withdrawal speed of the wellbore string being withdrawn from the wellbore based upon a duration between the identified repeating anomalies and a known length of the sections of the wellbore string.

The controller may be further arranged to (i) process the monitoring signals to identify repeating anomalies in the monitoring signals which are periodically repeated corresponding to joints between the sections of the wellbore string, and (ii) calculate a count of the sections withdrawn from the wellbore based on the repeating anomalies.

When the monitoring signals include a vibration sensor such that the respective monitoring signal of the vibration sensor is a vibration signal corresponding to vibrations measured in proximity to the wellbore string being withdrawn, the controller may be further arranged to use the vibration signal in identifying the repeating anomalies prior to calculating withdrawal speed or counting the withdrawn sections of the wellbore string.

When the controller processes the monitoring signals to identify repeating anomalies in the monitoring signals which are periodically repeated corresponding to joints between the sections of the wellbore string, the corresponding portions of the monitoring signals determined to be the repeating anomalies are further determined to be non-defect anomalies.

The controller may be further arranged to calibrate the monitoring sensors to balance baseline values between the monitoring signals when the monitoring signals correspond to one of the identified repeating anomalies. Preferably the controller is arranged to calibrate the monitoring sensors each time the wellbore string is at rest during withdrawal of the wellbore string from the wellbore.

The controller may be arranged to (i) compare the defect anomalies to more that one criterium and assign an intermediate similarity value to each criterium comparison, and (ii) quantify defectiveness of each section of the wellbore string by aggregating the intermediate similarity values. The controller may generate different levels of notifications based upon the quantified defectiveness of the wellbore string.

In some embodiments, the controller may be arranged to compare the defect anomalies to at least one defect criterium by similarity comparison of the defect anomalies to historical signal data indicative of defects and non-defects in wellbore strings. More particularly, a machine learning model may be trained using historical signal data having known signal patterns identified as relating to defects or non-defects in the wellbore string, so that the machine learning model can be subsequent used to detect portions of the monitoring signals which correspond to a defective section of the wellbore string.

According to a second aspect of the present invention there is provided a tubing monitoring apparatus for monitoring sections of a wellbore string as the wellbore string is withdrawn from a wellbore, the apparatus comprising:
a plurality of monitoring sensors arranged to (i) be supported above the wellbore in proximity to the wellbore string and (ii) generate respective monitoring signals as the wellbore string is withdrawn from the wellbore; and
a controller operatively connected to the monitoring sensors, the controller comprising a memory storing programming instructions and a processor arranged to process the programming instructions so as to be arranged to:
   (i) process the monitoring signals; and
   (ii) calculate a withdrawal speed of the wellbore string being withdrawn from the wellbore based upon the processed monitoring signals.

In one embodiment, the monitoring sensors include at least one electromagnetic sensor such that the respective monitoring signal of said at least one electromagnetic sensor is a magnetic flux leakage signal corresponding to magnetic flux leakage of the wellbore string, wherein the controller is further arranged to (i) process the monitoring signals to identify repeating anomalies in the monitoring signals which are periodically repeated corresponding to joints between the sections of the wellbore string; and (ii) calculate the withdrawal speed of the wellbore string being withdrawn from the wellbore based upon a duration between the identified repeating anomalies and a known length of the sections of the wellbore string.

According to another embodiment, the monitoring sensors include a mechanical instrument arranged to engage the wellbore string as the wellbore string is withdrawn to convert the motion of the wellbore string into a signal, such as an encoder, wherein the controller calculates the withdrawal speed of the wellbore string using the encoder signal.

According to a third aspect of the present invention there is provided a tubing monitoring apparatus for monitoring sections of a wellbore string as the wellbore string is withdrawn from a wellbore, the apparatus comprising:
a plurality of monitoring sensors arranged to (i) be supported above the wellbore in proximity to the wellbore string and (ii) generate respective monitoring signals, in which the monitoring sensors include at least one electromagnetic sensor such that the respective monitoring signal of said at least one electromagnetic sensor is a magnetic flux leakage signal corresponding to magnetic flux leakage of the wellbore string;
a controller operatively connected to the monitoring sensors, the controller comprising a memory storing programming instructions and a processor arranged to process the programming instructions so as to be arranged to:
   (i) process the monitoring signals to identify repeating anomalies in the monitoring signals which are periodically repeated corresponding to joints between the sections of the wellbore string; and
   (ii) calculate a count of the sections withdrawn from the wellbore based on the repeating anomalies.

According to a fourth aspect of the present invention there is provided a tubing monitoring apparatus for monitoring sections of a wellbore string as the wellbore string is withdrawn from a wellbore, the apparatus comprising:
a plurality of monitoring sensors arranged to (i) be supported above the wellbore in proximity to the wellbore string and (ii) generate respective monitoring signals, in which the monitoring sensors include at least one electromagnetic sensor such that the respective monitoring signal of said at least one electromagnetic sensor is a magnetic flux leakage signal corresponding to magnetic flux leakage of the wellbore string;
a controller operatively connected to the monitoring sensors, the controller comprising a memory storing programming instructions and a processor arranged to process the programming instructions so as to be arranged to:
   (i) process the monitoring signals to identify repeating anomalies in the monitoring signals which are periodically repeated corresponding to joints between the sections of the wellbore string; and
   (ii) calibrate the monitoring sensors to balance baseline values between the monitoring signals when the monitoring signals correspond to one of the identified repeating anomalies.

Preferably the controller is arranged to calibrate the monitoring sensors (i) between sections, or (ii) each time the wellbore string is at rest during withdrawal of the wellbore string from the wellbore.

### BRIEF DESCRIPTION OF THE DRAWINGS

Some embodiments of the invention will now be described in conjunction with the accompanying drawings in which:

FIG. 1 is schematic representation of a rig withdrawing tubing sections of a tubing string from a wellbore upon which the tubing monitoring apparatus according to the present invention is supported;

FIG. 2 is a schematic representation of electromagnetic monitoring sensors directed radially and axially of the tubing string;

FIG. 3 is a schematic representation of electromagnetic monitoring sensors directed radially and tangentially of the tubing string;

FIG. 4 is a schematic representation of the components of the tubing monitoring apparatus according to the present invention;

FIG. 5 is a schematic representation of some examples of monitoring signals output by vibration and electromagnetic sensors which are correlated with one another over time for use by the controller in distinguishing between defect and non-defect anomalies in the signals; and

FIG. 6 is a schematic representation of some additional examples of signals generated from the electromagnetic sensors for use by the controller in identifying sections of the wellbore string which are defective.

In the drawings like characters of reference indicate corresponding parts in the different figures.

### DETAILED DESCRIPTION

Referring to the accompanying figures, there is illustrated a tubing monitoring apparatus generally indicated by reference numeral 10. The apparatus 10 is particularly suited for monitoring a wellbore string, for example a tubing string 12 of the type comprising jointed tubing sections 14 which are connected longitudinally end to end with one another within a wellbore 16. The apparatus is also readily adaptable for operating in the manner described herein to monitor other wellbore strings such as a rod string comprises joined rod sections.

More particularly, the apparatus 10 is arranged to be supported on a rig 18 above the wellbore in which the rig is arranged for removing the wellbore string 12 from the wellbore 16 one section 14 at a time. An elevator 20 of the rig 18 is used to raise the uppermost section 14 above the rig so that the remaining wellbore string below the uppermost section 14 is suspended by the rig 18. After removal of the uppermost section 14, the elevator again raises the wellbore string by the length of one section so that the next section at the top end of the string can be similarly removed.

The apparatus 10 includes an arrangement of monitoring sensors 22 supported within a sensing unit surrounding the wellbore string as the string is withdrawn from the wellbore. Each monitoring sensor 22 produces a respective monitoring signal for analysis by the apparatus to identify any defects in the sections of the wellbore string. Each section is monitored in real time as it is displaced past the sensors 22 by the elevator when lifting the tubing string to remove each tubing section.

The apparatus 10 includes a controller 24 in communication with the monitoring sensors 22 to receive the monitoring signals therefrom for analysis in real time. The controller 24 communicates with an indicator 26 which outputs the results of the analysis of each tubing string by grading or classifying the tubing section according to one or more classes that indicates the degree of wear detected within the tubing section.

The apparatus 10 also includes an interface 28 in communication with the controller 24 which serves to communicate with one or more user devices 30 such as a personal computer, tablet or smart phone that can communicate instructions from the user to the controller as well as receive notifications from the controller that are directed towards a user of the apparatus.

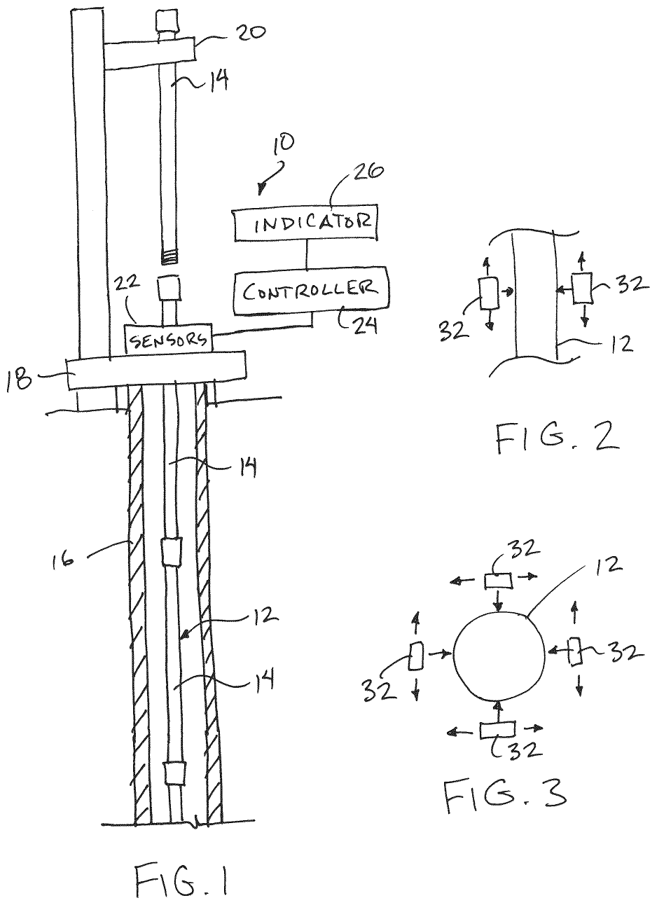

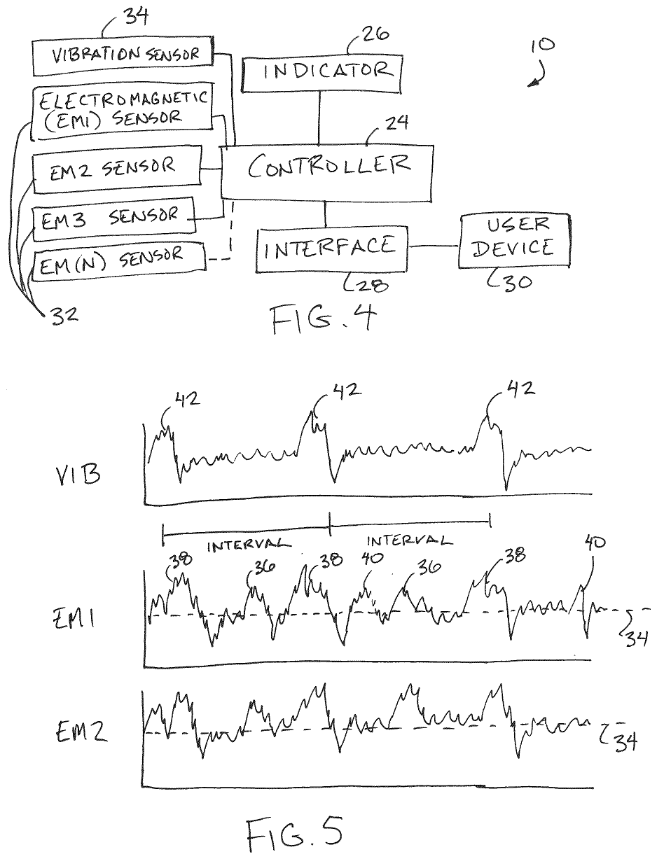

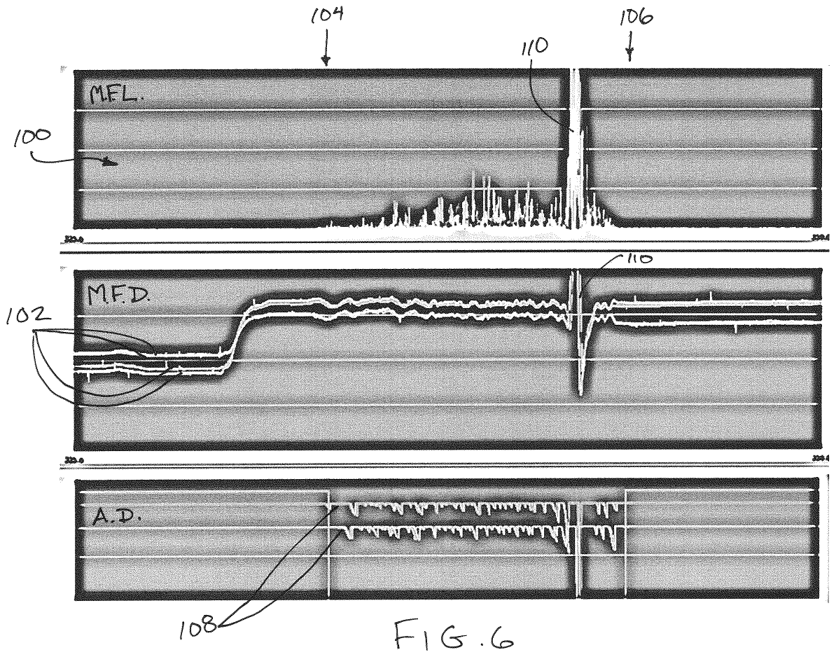

The monitoring sensors 22 include a plurality of electromagnetic sensors 32 directed at a prescribed orientation relative to the tubing string to generate monitoring signal including a magnetic flux leakage signal indicative of magnetic flux leakage and a magnetic flux density signal indicative of magnetic flux density. As shown in FIGS. 2 and 3, the electromagnetic sensors 32 may be circumferentially spaced about the tubing string. Furthermore, the sensors 32 typically include primary sensors directed radially inward and perpendicular to a surface of the tubing string, and secondary sensors which are directed (i) axially and parallel to a longitudinal axis of the tubing string or (ii) circumferentially/tangentially to the surface of the tubing string so as to be perpendicular to the longitudinal and radial axes. The different monitoring signals over time generated by the electromagnetic sensors 32 can be used to validate detected features (magnitude spikes over time) within the signals or to confirm erroneous features detected within the signals to assist in distinguishing between anomalous features in the signals that are associated with defects and anomalous features in the signals that are considered interference or non-defects of some form.

Anomalies as described herein correspond to signal variations or patterns that vary or deviate from normal baseline values that are representative of a continuous section of new and unworn tubing so as to be identifiable by the controller for consideration as a defect or non-defect in the tubing.

The monitoring sensors 22 may optionally include one or more vibration sensors 34 supported on the rig 18 in proximity to the electromagnetic sensors 32 so as to sense vibrations encountered by the suspended tubing string as the tubing string is displaced relative to the rig, or as a result of tools and other environmental factors on the rig surrounding the tubing string. The vibration sensor 32 may be an inertial measurement unit (IMU) including accelerometers and gyroscopes providing measurements along one or more axes to produce a vibration signal representative of external forces acting on the tubing string, for example by tools and equipment acting on the tubing string or by joints within the tubing string passing through the elevator that lifts the tubing string as each tubing section is removed.

The controller 24 is a computer device including a memory storing programming instructions thereon and a processor for executing the programming instructions to perform the various functions described herein. The controller 24 may comprise a single computer device or may comprise a plurality of separate computer devices in communication with one another over a local network, or over a remote communications network when part of the controller function is provided on a remote server for example. The controller 24 includes a communication interface for communication with the various monitoring sensors by wired or wireless communication, in addition to the user interface 28 arranged for communication with the user computer device 30 by wired or wireless means for example.

The user computer device 30 may communicate with the controller so as to receive programming selections input by an operator for directing operations of the controller including selections of modes or programmably adjusting various criteria or data stored on the controller for use in distinguishing between anomalies in the monitoring signals related to defects in the tubing and anomalies attributed to other influences other than defects. The user device 30 can also receive alerts of various forms or notifications indicating the graded result of the analysis of each tubing section for defects. Communication of the controller with a remote server, directly or through the user device can also allow for updating of the programming instructions on the controller and updates to the various criteria used in assessing the monitoring signals for defects in the tubing sections.

The indicator 26 serves primarily to output the results of the controller analysis of the monitoring signals to indicate to the operator as to a final grading of each tubing section. The output may be a single quantified value representative of an overall amount of wear associated with a particular tubing string. In some instances, the analysis by the controller includes analysis of various aspects or factors related to defects so that an intermediate value is determined in association with each aspect or factor being evaluated. Examples of different aspects or factors that may be evaluated include the depth of wear of one or more identified defects associated with a tubing section, an overall number of defects associated with a tubing section, the overall size of one or more defects associated with a tubing section, etc. With reference to depth of wear and other measurements, percentages are used when comparing the actual signal to the reference ones. These intermediate values can then be aggregated together to produce a final score or quantitative measure representative of the overall amount of wear of an individual tubing section, expressed as a percentage relative to reference signals.

The controller may also classify the wear associated with a tubing string into one of numerous categories having a prescribed notification colour associated therewith. The categories in a preferred embodiment include (i) yellow to indicate substantially new tubing that is substantially devoid of defects or has up to 15% wear, (ii) blue to indicate between 15% and 30% wear in a tubing section, (iii) green to indicate between 30% and 50% wear in a tubing section, and (iv) red to indicate greater than 50% wear in the tubing section. The actual percentages defining each range most commonly correspond to the above noted percentages from API 5c which are most widely used; however, the limits for each range are controllably adjustable through an application running on the user device 30 that interfaces with the controller 24 so that some users can ask for different settings and can make adjustments on the setup configuration tab of the application. When using colours to indicate ranges as noted above, the indicator may include colour display lights in which the amount of wear as determined by the controller analysis of the monitoring signals in real time is communicated to the user as the corresponding tubing section is separated from the tubing string by illuminating the indicator light having a colour corresponding to the calculated grade of the tubing section.

In operation, the monitoring signals continuously monitor various variables as the tubing string is displaced past the sensors during withdrawal of the tubing string. The controller processes the monitoring signals by identifying anomalies in the signals, which may be magnitude spikes in the measured values that exceed a threshold level 34 for a duration exceeding a threshold duration, followed by distinguishing the anomalies between defect anomalies representing a defect in the tubing string and non-defect anomalies representing anomalies from other sources other than defects.

The processing of the monitoring signals may also include a filtering or smoothing of the signals using various signal processing techniques. The processing may include a continuous signal sequence algorithm to indicate absolute signal variations as the main feature of the algorithm to extract the absolute values of signal changes without using signal attenuation or filtering. In some instances, this may include comparison of the signals to baseline values to eliminate some anomalies from consideration as defects if the anomalies in the signal can be attributed to background noise represented by the baseline values.

The processing of the monitoring signals typically also includes correlating the monitoring signals from different sensors with one another by aligning the signals over time to identify similar patterns between different monitoring signals which may either confirm certain features to be defect anomalies or confirm certain features to be non-defect anomalies. The process also includes assigning a unit value to a group of signals with a scale based on signal relevance that once added together balance with each other signals values producing a mathematical outcome with the most probable joint condition. For example, electromagnetic signals may be compared to the vibration signal from one or more vibration sensors so that anomalies appearing in the electromagnetic signals but not the vibration signal are deemed defect anomalies 36. Alternatively, anomalies above a threshold level in the electromagnetic signals that correlate or correspond to similar anomalies in the vibration signal may be explained as outside interference from machinery and the like or the presence of a joint in the tubing string passing through the elevator which are deemed as non-defect anomalies 38. In other instances when similar anomalies in the signals above a threshold level 34 appear in two different electromagnetic signals, the signals may be used to validate one another that the anomalies are in fact defect anomalies 36; however, anomalies appearing in only one electromagnetic signal but not others may be deemed non-defect anomalies 40.

The controller may also analyse the monitoring signals, and particularly the vibration signal for repetitive spikes in the signal determined to be periodic anomalies 42 that repeat at periodic intervals once the signals have been corrected for time and speed relative to one another. Such periodic anomalies 42 may be determined to be the result of a joint between tubing sections passing through the sensors to further confirm that corresponding anomalies in the electromagnetic signals are also non-defect anomalies 38. The repeating periodic anomalies are typically readily identifiable by their overall magnitude and/or by the pattern of the monitoring signals at repeating intervals of time.

Any anomalies which cannot be explained as non-defects resulting from other interferences when correlating the different monitoring signals relative to one another or by pattern recognition within the signals, are typically deemed to be a defect anomaly that may require further analysis by the controller to determine the severity of the identified defect anomaly in the signal and thus the corresponding degree of defectiveness of the tubing string by comparison to various defect criteria. This subsequent analysis may involve comparison to thresholds relating to magnitude of the anomaly or duration of the anomaly or a combination thereof that define the defect criteria applied in quantifying the defectiveness of the tubing string. The defect criteria stored on the controller in this instance may be adjusted once the speed of withdrawal of the tubing string has been determined for example.

In further instances, the controller may include various historical data stored thereon which identifies signal patterns indicative of defect and non-defects such that the controller may apply matching algorithms to identify an anomaly in the signal as being a defect anomaly or a non-defect anomaly based on a similarity comparison to the historical data and patterns stored on the controller.

The monitoring signals recorded by the controller can also be used for identifying joints in the tubing string as described above for use in calculating the speed of withdrawal of the tubing string and/or for counting the number of tubing sections removed during withdrawal of the tubing string.

The controller may apply pattern recognition to identify repetitive anomalies in one or more of the electromagnetic signals and/or repetitive anomalies in the vibration signal.

In preferred instances, the controller uses multiple monitoring signals and monitoring signals of different types including an electromagnetic signal and a vibration signal compared to one another to better confirm periodic and repeating anomalies indicative of joints. Once the joints have been identified, the number of tubing sections removed during withdrawal of a tubing string can be counted by simply counting each passing joint represented in the signal by an identified repeating anomaly.

With the length of the tubing sections being standardized and known by the controller, the time interval between joints being removed and the length of the tubing string can be used together to calculate the speed of withdrawal. The withdrawal speed can then be used as an input to the controller in the analysis of the monitoring signals to distinguish between defect anomalies and non-defect anomalies as the patterns used in similarity comparisons or the thresholds used as defect criteria are adjusted to match the identified withdrawal speed so that the analysis of the signal anomalies can be performed more precisely.

As noted above, some of the analysis of the monitoring signals may include comparison of the signals to one or more baseline values used in filtering the signals for background noise and for classification of anomalies that exceed a prescribed threshold amount to be considered for defectiveness. The baseline values can be measured on site using the same monitoring sensors 22 by using the sensors to monitor electromagnetic signals and vibrations when the tubing string is at rest as each tubing section is removed from the tubing string. Removal of each tubing section typically involves lifting the tubing string with the elevator by the height of one tubing section, followed by anchoring of the remaining tubing string relative to the rig 18 to be suspended within the wellbore, followed by use of tools to unscrew the uppermost tubing section from the remainder of the tubing string. The elevator then lifts the tubing string again by the length of another tubing section. When the rig is briefly at rest either immediately before or immediately after the application of tools to unscrew the uppermost tubing section, the measured monitoring signal values can be used to recalibrate and balance the baseline values that are subsequently used in analysing the signals that are acquired as the tubing string is moved past the sensors in the next cycle. Recalibrating the baseline values among the electromagnetic sensors to be identical to one another when the string is at rest following each lifting operation results in the baseline values used in signal analysis being dynamically calibrated throughout the operation of withdrawing the tubing string in real time.

Data related to each tubing section is collected between identified periodic anomalies in the signals as the corresponding tubing section is lifted past the sensors. The controller may analyse the signal in batches in which each section of the monitoring signals being analysed for defects are associated with a particular tubing section such that any defects identified and any intermediate values associated with any identified defects or other defect related factors associated with the section of the monitoring signals being analysed can be associated with a single tubing section and contribute in an aggregate manner to the overall grading of that tubing section.

According to one aspect of the invention, the apparatus 10 provides an improved manner in accommodating for mechanical interference. Currently it is the operator's task to validate signals to ensure they are caused by defects or anomalies in the inspected part, not by external factors like electromagnetic interference and operating conditions such as engine vibrations, tool impacts, or general “moving around of people/items” that cause vibrations or introduce electromagnetic interference. Signal interaction starts with validation and filtering. To ensure accuracy in this part of the process, the apparatus 10 includes the installation of a vibration sensor 34 to the EMI Unit 30 to help eliminate signals produced by sharp impacts and help reduce the signal variation due to undesirable/uncontrol movements of the tubing. The apparatus 10 combines traditional magnetic flux leakage (MFL) sensors with vibration sensors placed strategically in the unit. The MFL sensors detect magnetic fields in different orientations relative to the surface being inspected (parallel or perpendicular). The newly included hardware (vibration sensors) read unexpected movements and interferences. Real-time data from these sensors are continuously collected during the inspection process and analyzed by the new software. The vibration sensor converts real life vibrations and movements into digital data. The controller software then compares this data in real time to the EMI data being constantly collected in the same timestamp/instant. By doing this the software is instantly able to eliminate false signals caused by any tiny movement on the equipment, allowing only true MFL readings to be used to interpret the tubulars condition. No other known system allows for the ability to eliminate false mechanical signals in real time using the interaction of two or more signal channels.

According to another aspect of the invention, the apparatus 10 enables measurement of withdrawal speed and counting of tubing sections removed. In current systems, the MFL sensor signals may need adjustment based on the speed at which the part moves through the sensors. Sensors may operate differently at high versus low speeds. The faster the tubular moves through the EMI unit, it basically stretches the MFL signal, so if you don't compensate for the increase in speed, it will effectively increase the size of the readings. These increased readings can often then be interpreted by the operator as larger flaws than they are. The opposite is also true if they go slower, where the signal is compressed, making flaws look smaller than they are. Using a unique combination of vibration sensors and programming instructions on the controller, the apparatus 10 can time each joint and correct itself in real time, vastly reducing flawed indicators due to speed of pulling. In order to do this, the addition of a vibration sensor in some embodiments gives off a readable/repeatable data signal every time a tubing collar, or other marker joint goes through the EMI. Using this recurring marker signal, the software can count the numbers of joints that go through it and measure the speed at which they are pulled. This unique ability allows for a digital count of the tubulars (which often the operators can get wrong because they either over count or under count due to information overload).

The controller also performs a dynamic calibration that allows the system to reset values automatically while tubing is at rest. This creates a steady, stabilized baseline to read from for each individual piece being inspected for flaws. This means that the software can adjust baseline values back to the baseline value (which is normally new pipe values) automatically whenever the rig/pulling unit stops to break/make a connection. This allows for consistency in reading the signals coming from the sensors, even if the rig/pulling unit is varying its speed (as they all do). Prior to this the operator needed to be able diagnose and then manually adjust these values.

According to another aspect of the present invention, the apparatus 10 also provides an improved manner of analysing and interpreting the monitoring signals from the sensors. There is a complex relationship between the signals detected by different sensors. This relationship needs to be analyzed to form a cohesive understanding of the condition of the inspected part. The nature of this relationship could involve how signals correlate across different sensors and orientations to indicate the presence and characteristics of defects.

The software on the controller plays a crucial role in processing this complex data in real time for final assessment of the monitoring signals. It performs signal validation, adjusts signals for speed variations, and analyzes the relationships between signals to provide a final assessment of the part's condition. This continuous process ensures that the inspection is thorough and precise throughout the length of the part being inspected. The software on the controller also assigns values to various factors and aggregates these values to generate a final assessment for each section of data. his final outcome or analysis is presented on a scale that indicates the condition of the part, providing a level of quality and precision that surpasses traditional methods.

While it would be challenging for a human operator to maintain concentration and precision over long periods, the software on the controller excels at processing vast amounts of data and detecting subtle patterns or anomalies that may indicate defects. The software's ability to analyze data points that are beyond human perceptual capabilities enhances the overall quality and reliability of the inspection process.

In essence, the apparatus 10 leverages advanced sensor technology and sophisticated software algorithms to enhance the accuracy, efficiency, and reliability of electromagnetic inspections, particularly in detecting and characterizing defects in tubing as it is tripped out of hole. This integration of mechanical sensors and software allows for a level of inspection precision that was previously unattainable, significantly improving quality control in industrial applications.

According to some embodiments, the monitoring apparatus can also effectively monitor a wellbore string 12 to determine if any sections 14 of the string are defective as the string is withdrawn from the wellbore without the use of the vibration sensors described above. In one example, the apparatus analyses the monitoring signals from each of the electromagnetic sensors 32 to process both the magnetic flux leakage signal 100 indicative of measured magnetic flux leakage and the magnetic flux density signal 102 indicative of measured magnetic flux density output from the sensors as shown in FIG. 6. Similarly to the process described above, the apparatus is arranged to identify repeating anomalies in the monitoring signals which are periodically repeated corresponding to joints between the sections of the wellbore string. In particular, as each set of electromagnetic sensors passes by one of the joints, the sensors tend to be deflected away from the string to produce large magnitude spikes with a readily identifiable pattern in the signals resulting from a process referred to as end effect. One such repeating anomaly indicative of a joint as a result of end effect is illustrated by the peaks 110 shown in FIG. 6. FIG. 6 illustrates the signals collected from a single section of the wellbore string passing the sensors in which only a single end effect is identified.

In this example, the apparatus processes the signals by initially comparing the magnetic flux leakage signals 100 to a minimum threshold which identifies a portion of the magnetic flux leakage signal that is relevant to one section of the string and which is to be monitored for defects in the string. More particularly, the region between repeating anomalies identifiable by end affect, or between start and stop of the wellbore string withdrawal can be associated with one section of the wellbore string having an identifiable start 104 where the magnetic flux leakage signal begins to exceed the minimum threshold and an end 106 where the magnetic flux leakage signal returns below the minimum threshold after one of the peaks 110 indicating end affect has been produced.

Once a relevant section of the magnetic flux leakage signal has been identified, as a region between repeating anomalies identifiable as joints and/or a region exceeding the minimum threshold, the corresponding region of the magnetic flux density signal is then processed for each of the sensors 32. This process involves identifying peaks relating to features or anomalies in the signals followed by generating an accumulated differential signal 108 as shown in FIG. 6 which represents an accumulated differential of the identified features in the magnetic flux density signal. The aggregated features from the magnetic flux density signal, as represented by peaks in the accumulated differential signal 108, can then be compared to a defect threshold to determine if the aggregated features represent a defect or not. This process of accumulated differential acts as a form of filtering of the signal so that minor vibration effects on the signal cancel each other out.

Prior to comparison of the peaks in the accumulated differential signal 108 to the defect threshold, the apparatus calculates the withdrawal speed as described above based upon a duration between identifiable repeating anomalies corresponding to joints between sections of the wellbore string and a known length of the sections of the wellbore string. If the calculated withdrawal speed falls outside of a default speed range associated with the defect threshold, and particularly if the withdrawal speed of the string is deemed to be below the default speed range, then a correction factor is applied to the accumulated differential signal 108 to alter or boost the signal strength and increase the magnitude of the peaks before comparison to the defect threshold otherwise associated with the default speed range.

The comparison of peaks of the accumulated differential signal 108 to the default threshold can be performed in real-time for each peak. Alternatively, subsequent to identification of the ends of a corresponding section of the wellbore string, the greatest magnitude peak or peaks of the accumulated differential signal 108 can be compared to the defect threshold to deem the entirety of that section of the wellbore string to be defective or non-defective.

Each time the wellbore string is at rest after a prescribed one or more sections have been withdrawn, the monitoring signals from the different electromagnetic sensors 32, and particularly the magnetic flux leakage signal 100 and/or the magnetic flux density signal 102, are compared to one another where an end effect is identified in the signal corresponding to a repeating anomaly determined to be a joint. Any sensors 32 which are deemed to be out of balance with the other sensors can be calibrated so that the measured baseline values are balanced across all of the sensors 32.

As described herein the apparatus 10 provides a sophisticated electromagnetic inspection system using magnetic flux leakage (MFL) sensors combined with additional sensors in an electromagnetic (EMI) unit.

Sensor Combination and Real-Time Data Capture: The system combines traditional MFL sensors with additional sensors placed strategically. These sensors detect magnetic fields in different orientations relative to the surface being inspected (parallel or perpendicular). Real-time data from these sensors is continuously collected during the inspection process.

Signal Validation/Adjustment Software combined with Vibration sensing hardware and/or Speed sensing: The operator's first task is to validate signals to ensure they are caused by defects or anomalies in the inspected part, not by external factors like electromagnetic interference and operating conditions such as engine vibrations, tool impacts, or general “moving around of people/items” that cause vibrations or introduce electromagnetic interference. Signals may need adjustment based on the speed at which the part moves through the sensors. Sensors may operate differently at high versus low speeds. Signal interaction starts with validation and filtering.

A vibration sensor is optionally used to help eliminate signals produced by sharp impacts and help reduce the signal variation due to undesirable/uncontrolled movements of the tubing. The software also introduces the concept of dynamic calibration described above that allows the system to reset values automatically while the tubing string is at rest. This creates a steady stabilised baseline to read from for each individual tubing section being inspected for flaws.

A speed sensor is optionally used for calculating withdrawal speed. The speed sensor is a mechanical instrument arranged to engage or interact with the wellbore string as the wellbore string is withdrawn to convert the motion of the wellbore string into a signal. In one example, the speed sensor is an encoder arranged to generate an encoder signal based on the movement of the wellbore string, wherein the controller calculates the withdrawal speed of the wellbore string using the encoder signal. This calculation of withdrawal speed by processing the encoder signal generated by the encoder can be used as an alternative to processing the signals from the electromagnetic sensors to calculate withdrawal speed as an input to any of the embodiments discussed above.

Relationship Between Signals: There is a complex relationship between the signals detected by different sensors. This relationship needs to be analyzed to form a cohesive understanding of the condition of the inspected part. The nature of this relationship could involve how signals correlate across different sensors and orientations to indicate the presence and characteristics of defects.

Final Assessment and Software Role: The software will play a crucial role in processing this complex data in real time. It performs signal validation, adjusts signals for speed variations, and analyzes the relationships between signals to provide a final assessment of the part's condition. This continuous process ensures that the inspection is thorough and precise throughout the length of the part being inspected.

Point-Based Analysis and Final Outcome: The software assigns values to various factors and aggregates these values to generate a final assessment for each section of data. This final outcome or analysis is presented on a scale that indicates the condition of the part, providing a level of quality and precision that surpasses traditional methods.

Human vs. Computer Capabilities: While it would be challenging for a human operator to maintain concentration and precision over long periods, the software excels at processing vast amounts of data and detecting subtle patterns or anomalies that may indicate defects. The software's ability to analyze data points that are beyond human perceptual capabilities enhances the overall quality and reliability of the inspection process.

Since various modifications can be made in the invention as herein above described, and many apparently widely different embodiments of same made, it is intended that all matter contained in the accompanying specification shall be interpreted as illustrative only and not in a limiting sense.

1. A monitoring apparatus for monitoring sections of a wellbore string for defects in the sections as the wellbore string is withdrawn from a wellbore, the apparatus comprising:
a plurality of monitoring sensors arranged to (i) be supported above the wellbore in proximity to the wellbore string and (ii) generate respective monitoring signals, in which the monitoring sensors include at least one electromagnetic sensor such that the respective monitoring signal of said at least one electromagnetic sensor includes a magnetic flux leakage signal corresponding to a measured magnetic flux leakage of the wellbore string;
a controller operatively connected to the monitoring sensors, the controller comprising a memory storing programming instructions and a processor arranged to process the programming instructions so as to be arranged to:
(i) process the monitoring signals from the monitoring sensors as the wellbore string is withdrawn from the wellbore to identify one or more defect anomalies in the monitoring signals which may relate to defects in the wellbore string;
(ii) for each section, compare the one or more defect anomalies to at least one defect criterium stored on the controller to determine if the section of the wellbore string associated with one or more of the defect anomalies is defective; and
(iii) generate a notification based on the determination that one of the sections is determined to be defective.

2. The apparatus according to claim 1 wherein the controller is arranged to process the monitoring signals from the monitoring sensors in real time as the wellbore string is withdrawn from the wellbore to distinguish the defect anomalies in the monitoring signals from non-defect anomalies not relating to defects in the wellbore string.

3. The apparatus according to claim 1 wherein the controller is arranged to process the monitoring signals to identify the defect anomalies by combining features from the monitoring signals of the plurality of monitoring sensors.

4. The apparatus according to claim 1 wherein said at least one electromagnetic sensor comprises a plurality of electromagnetic sensors in which one or more of the electromagnetic sensors are oriented radially of the wellbore string and one or more of the electromagnetic sensors are oriented parallel or tangentially of the wellbore string.

5. The apparatus according to claim 1 wherein the at least one defect criterium includes one or more thresholds against which the identified defect anomalies of the monitoring signals are compared.

6. The apparatus according to claim 1 wherein the monitoring signals further include a magnetic flux density signal corresponding to a measured flux density of the wellbore string and wherein the controller is arranged to process the monitoring signals to determine if the section of the wellbore is defective by (i) identifying portions of the magnetic flux leakage signal that are relevant to defects in the wellbore string, (ii) process corresponding portions of the magnetic flux density signal that correspond to the identified portions of the magnetic flux leakage signal to generate an accumulated differential signal, in which the accumulated differential signal represents an accumulated differential of the magnetic flux density signal for each of said corresponding portions of the magnetic flux density signal, and (iii) compare at least a portion of the accumulated differential signal to said at least one defect criterium.

7. The apparatus according to claim 6 wherein said at least one defect criterium includes a defect threshold and wherein the controller is arranged to compare a maximum peak of the accumulated differential signal associated with the section of the wellbore string to the defect threshold to determine if the section of the wellbore is defective.

8. The apparatus according to claim 6 wherein the controller is arranged to identify said portions of the magnetic flux leakage signal that are relevant to defects in the wellbore string by (i) identifying repeating anomalies in the monitoring signals which are periodically repeated corresponding to joints between the sections of the wellbore string, (ii) identifying a region of the magnetic flux signal between two of the repeating anomalies as being associated with one section of the wellbore string, and (iii) comparing said identified region of the magnetic flux leakage signal to a minimum threshold.

9. The apparatus according to claim 1 wherein the controller is further arranged to calculate withdrawal speed of the wellbore string being withdrawn from the wellbore and use the withdrawal speed in processing the monitoring signals to determine if the section is defective.

10. The apparatus according to claim 9 wherein the controller is arranged to (i) determine if the calculated withdrawal speed falls outside of a default speed and (ii) when the calculated withdrawal speed is determined to be outside of a default speed, apply a correction factor to the identified defect anomalies of the monitoring signals prior to comparison of the defect anomalies to the defect criterium to determine if the section of the wellbore string associated with one or more of the defect anomalies is defective.

11. The apparatus according to claim 1 wherein the controller is arranged to (i) process the monitoring signals to identify repeating anomalies in the monitoring signals which are periodically repeated corresponding to joints between the sections of the wellbore string, and (ii) calculate a withdrawal speed of the wellbore string being withdrawn from the wellbore based upon a duration between the identified repeating anomalies and a known length of the sections of the wellbore string.

12. The apparatus according to claim 11 wherein the monitoring signals include a vibration sensor such that the respective monitoring signal of the vibration sensor is a vibration signal corresponding to vibrations measured in proximity to the wellbore string being withdrawn, and wherein the controller is arranged to use the vibration signal in identifying the repeating anomalies.

13. The apparatus according to claim 1 wherein the controller is arranged to (i) process the monitoring signals to identify repeating anomalies in the monitoring signals which are periodically repeated corresponding to joints between the sections of the wellbore string, and (ii) calculate a count of the sections withdrawn from the wellbore based on the repeating anomalies.

14. The apparatus according to claim 13 wherein the monitoring signals include a vibration sensor such that the respective monitoring signal of the vibration sensor is a vibration signal corresponding to vibrations measured in proximity to the wellbore string being withdrawn, and wherein the controller is arranged to use the vibration signal in identifying the repeating anomalies.

15. The apparatus according to claim 1 wherein the controller is arranged to (i) process the monitoring signals to identify repeating anomalies in the monitoring signals which are periodically repeated corresponding to joints between the sections of the wellbore string, and (ii) determine the repeating anomalies to be non-defect anomalies.

16. The apparatus according to claim 1 wherein the controller is arranged to (i) process the monitoring signals to identify repeating anomalies in the monitoring signals which are periodically repeated corresponding to joints between the sections of the wellbore string, and (ii) calibrate the monitoring sensors to balance baseline values between the monitoring signals when the monitoring signals correspond to one of the identified repeating anomalies.

17. The apparatus according to claim 16 wherein the controller is arranged to calibrate the monitoring sensors each time the wellbore string is at rest during withdrawal of the wellbore string from the wellbore.

18. The apparatus according to claim 1 wherein the controller is arranged to compare the defect anomalies to more that one criterium and assign an intermediate similarity value to each criterium comparison, and wherein the controller is arranged to quantify defectiveness of each section by aggregating the intermediate similarity values.

19. The apparatus according to claim 18 wherein the controller is arranged to generate different levels of notifications based upon the quantified defectiveness of the wellbore string.

20. The apparatus according to claim 1 wherein the controller is further arranged to compare the defect anomalies to at least one defect criterium by similarity comparison of the defect anomalies to historical signal data indicative of defects and non-defects in wellbore strings.

21. A tubing monitoring apparatus for monitoring sections of a wellbore string as the wellbore string is withdrawn from a wellbore, the apparatus comprising:
a plurality of monitoring sensors arranged to (i) be supported above the wellbore in proximity to the wellbore string and (ii) generate respective monitoring signals as the wellbore string is withdrawn from the wellbore; and
a controller operatively connected to the monitoring sensors, the controller comprising a memory storing programming instructions and a processor arranged to process the programming instructions so as to be arranged to:
(i) process the monitoring signals; and
(ii) calculate a withdrawal speed of the wellbore string being withdrawn from the wellbore based upon the processed monitoring signals.

22. A tubing monitoring apparatus for monitoring sections of a wellbore string as the wellbore string is withdrawn from a wellbore, the apparatus comprising:
a plurality of monitoring sensors arranged to (i) be supported above the wellbore in proximity to the wellbore string and (ii) generate respective monitoring signals, in which the monitoring sensors include at least one electromagnetic sensor such that the respective monitoring signal of said at least one electromagnetic sensor is a magnetic flux leakage signal corresponding to magnetic flux leakage of the wellbore string;
a controller operatively connected to the monitoring sensors, the controller comprising a memory storing programming instructions and a processor arranged to process the programming instructions so as to be arranged to:
(i) process the monitoring signals to identify repeating anomalies in the monitoring signals which are periodically repeated corresponding to joints between the sections of the wellbore string; and
(ii) calculate a count of the sections withdrawn from the wellbore based on the repeating anomalies.

23. A tubing monitoring apparatus for monitoring sections of a wellbore string as the wellbore string is withdrawn from a wellbore, the apparatus comprising:
a plurality of monitoring sensors arranged to (i) be supported above the wellbore in proximity to the wellbore string and (ii) generate respective monitoring signals, in which the monitoring sensors include at least one electromagnetic sensor such that the respective monitoring signal of said at least one electromagnetic sensor is a magnetic flux leakage signal corresponding to magnetic flux leakage of the wellbore string;
a controller operatively connected to the monitoring sensors, the controller comprising a memory storing programming instructions and a processor arranged to process the programming instructions so as to be arranged to:
(i) process the monitoring signals to identify repeating anomalies in the monitoring signals which are periodically repeated corresponding to joints between the sections of the wellbore string; and
(ii) calibrate the monitoring sensors to balance baseline values between the monitoring signals when the monitoring signals correspond to one of the identified repeating anomalies.

24. The apparatus according to claim 23 wherein the controller is arranged to calibrate the monitoring sensors (i) between sections, or (ii) each time the wellbore string is at rest during withdrawal of the wellbore string from the wellbore.
